(19) United States
(12) Patent Application Publication
(10) Pub. No.: US 2021/0116629 A1
(43) Pub. Date: Apr. 22, 2021

(54) REFLECTION SHEET, EDGE-LIT BACKLIGHT MODULE, AND LCD DEVICE

(71) Applicant: Shenzhen China Star Optoelectronics Technology Co., Ltd., Shenzhen (CN)

(72) Inventors: Lizhi Sun, Shenzhen (CN); Xiangyang Xu, Shenzhen (CN)

(21) Appl. No.: 16/319,314

(22) PCT Filed: Sep. 26, 2018
(86) PCT No.: PCT/CN2018/107778

§ 371 Date: Jan. 18, 2019

(30) Foreign Application Priority Data
Jun. 25, 2018 (CN) 201810661983.1

(51) Int. Cl. F21V 8/00; G02F 1/1333

(52) U.S. Cl. CPC G02B 6/0055; G02B 6/0046; G02F 1/133308

(57) ABSTRACT

The present invention teaches a reflection sheet, an edge-lit backlight module, and a LCD device. The edge-lit backlight module includes a back plate and, inside the back plate, a light source, a reflection sheet, and a light guide plate. The light source is disposed to a lateral side of the light guide plate. The reflection sheet is disposed between the back plate and the light guide plate. Multiple protrusions are provided on a side of the reflection sheet adjacent to the light guide plate. Multiple indentations are provided on a bottom side of the light guide plate adjacent to the reflection sheet. The protrusions and indentations are able to reflect light from various directions so that more light is incident into the light guide plate and emitted out through the light emission face of the light guide plate, enhancing light utilization and emission uniformity.

### FIELD OF THE INVENTION

The present invention is generally related to the field of display technology, and more particularly to a reflection sheet, an edge-lit backlight module, and a liquid crystal display (LCD) device.

### BACKGROUND OF THE INVENTION

Liquid crystal display (LCD) devices are widely applied to TVs, mobile phones, personal digital assistants (PDAs), digital cameras, computer screens, and notebook screens, due to their thin thickness, high quality, power saving, and low radiation.

Currently most commercially available LCD devices are back-lighted LCD devices, which include a casing, a backlight module inside the casing, and a LCD panel inside the casing.

A backlight module may be categorized as edge-lit or direct-lit backlight module according to where backlight is incident into the LCD panel. A direct-lit backlight module provides a planar light source to the LCD panel by placing cold cathode fluorescent lamp (CCFL) or light emitting diode (LED) light bar behind the LCD panel. An edge-lit backlight module uses LED light bar as light source 130 and has the light source 130 disposed to a side of the light guide plate 150. Light form the LED light bar enters the light guide plate 150 from a light incident face of the light guide plate 150, undergoes reflection and scattering, and then out of the light guide plate 150 through a light emission face. The light then passes through optical films and forms a planar backlight to the LCD panel.

As shown in FIG. 1, a conventional edge-lit backlight module includes a light guide plate 150, a LED light source 130 disposed to a lateral side of the light guide plate 150, a reflector 170, grid dots 180 for reflection and scattering on the light guide plate 150, a reflection sheet 140 beneath the light guide plate 150, and optical films 160 above the light emission face of the light guide plate 150. For the conventional edge-lit backlight module, light entering the light guide plate 150 is reflected by the grid dots 180 and scattered out of the light emission face of the light guide plate 150. As shown in FIG. 2, however, the shape and distribution of the grid dots 180 are planar, and light therefore undergoes insufficient reflection and scattering. The light source therefore has an inferior utilization, and the provided backlight suffers limited uniformity.

### SUMMARY OF THE INVENTION

An objective of the present invention is to teach a reflection sheet capable of reflecting light from various directions, thereby enhancing light utilization.

Another objective of the present invention is to teach an edge-lit backlight module having higher utilization to light from the backlight source and having better uniformity to the light guide plate.

Yet another objective of the present invention is to teach a LCD device having higher utilization to light from the backlight source and having better uniformity to the light guide plate.

To achieve the objectives, the present invention teaches a reflection sheet comprising a main member and a plurality of protrusions disposed on a side of the reflection sheet.

The protrusions have their dimension and density gradually increased from a lateral side of to another lateral side of the main member, or have their dimension and density gradually increased from two lateral sides to a center of the main member.

The present invention also teaches an edge-lit backlight module comprising a back plate, and a light source, a reflection sheet, and a light guide plate all housed inside the back plate;

the light source is disposed to a lateral side of the light guide plate; the reflection sheet is disposed between the back plate and the light guide plate; the reflection sheet has a plurality of protrusions on a side adjacent to the light guide plate protruding towards the light guide plate; and the light guide plate has a plurality of indentations on a bottom side adjacent to the reflection sheet indented away from the reflection sheet.

There is one light source; the protrusions have greater dimensions and densities on the reflection sheet as they are located farther away from the at least one light source; the indentations have greater dimensions and densities on the light guide plate as they are located farther away from the at least one light source.

Each protrusion on the reflection sheet is aligned with a corresponding indentation on the light guide plate; and the protrusion and the corresponding indentation are complementarily shaped and of an identical dimension.

The light guide plate has a wedge shape; a side of the light guide plate adjacent to the at least one light source has a greater thickness than that of another side away from the at least one light source; and the reflection sheet is disposed parallel to the bottom side of the light guide plate.

There are two light sources respectively disposed to two opposite lateral sides of the light guide plate; the protrusions have greater dimensions and densities as they are located farther away from the two light sources and closer to a middle section of the reflection sheet; and the indentations have greater dimensions and densities as they are located farther away from the two light sources and closer to a middle section of the light guide plate.

Each protrusion on the reflection sheet is aligned with a corresponding indentation on the light guide plate; and the protrusion and the corresponding indentation are complementarily shaped and of an identical dimension.

The back plate comprises a bottom plate and a plurality of side plates perpendicularly joined to edges of the bottom plate; and

the light guide plate comprises a light emission face away from the bottom plate, a bottom face adjacent to the bottom plate, and a light incident face adjacent to a side plate.

The present invention further teaches a LCD device, comprising a backlight module, a LCD panel disposed on top of the backlight module, a plastic frame disposed between the backlight module and the LCD panel, and a casing covering circumferential areas of the LCD panel, the backlight module, and the plastic frame.

The backlight module is an edge-lit backlight module described above.

The advantages of the present invention are as follows. The reflection sheet taught by the present invention includes a main member and multiple protrusions disposed on the main member. The reflection sheet is able to reflect light from various directions, thereby enhancing light utilization. The edge-lit backlight module taught by the present invention includes a back plate and, inside the back plate, a light source, a reflection sheet, and a light guide plate. The light source is disposed to a lateral side of the light guide plate. The reflection sheet is disposed between the back plate and the light guide plate. Multiple protrusions are provided on a side of the reflection sheet adjacent to the light guide plate. Multiple indentations are provided on a bottom side of the light guide plate adjacent to the reflection sheet. The protrusions and indentations are able to reflect light from various directions so that more light is incident into the light guide plate and emitted out through the light emission face of the light guide plate, enhancing light utilization and emission uniformity. The LCD device taught by the present invention includes the above-described edge-lit backlight module. Through the multiple protrusions provided on a side of the reflection sheet adjacent to the light guide plate and multiple indentations provided on a bottom side of the light guide plate adjacent to the reflection sheet, the protrusions and indentations are able to reflect light from various directions so that more light is incident into the light guide plate and emitted out through the light emission face of the light guide plate, thereby enhancing light utilization and emission uniformity and improving display quality of the LCD device.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a structural schematic diagram of a conventional edge-lit backlight module.

FIG. 2 is a schematic diagram showing light trajectories inside the conventional edge-lit backlight module of FIG. 1.

FIG. 3 is a structural schematic diagram showing a reflection sheet according to an embodiment of the present invention.

FIGS. 4 and 5 are schematic diagrams showing the distribution of protrusions on the reflection sheet of FIG. 3.

FIG. 6 is a structural schematic diagram showing an edge-lit backlight module according a first embodiment of the present invention.

FIG. 7 is a structural schematic diagram showing the light guide plate of the edge-lit backlight module of FIG. 6.

FIG. 8 is a structural schematic diagram showing an edge-lit backlight module according a second embodiment of the present invention.

FIG. 9 is a structural schematic diagram showing the light guide plate of the edge-lit backlight module of FIG. 8.

FIG. 10 is a structural schematic diagram showing a LCD device according a first embodiment of the present invention.

FIG. 11 is a structural schematic diagram showing a LCD device according a second embodiment of the present invention.

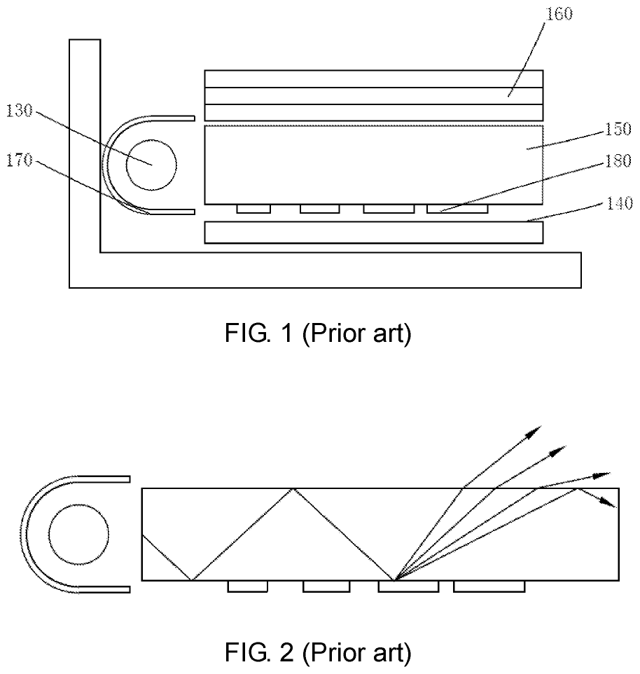

### DETAILED DESCRIPTION OF PREFERRED EMBODIMENTS

The following descriptions for the respective embodiments are specific embodiments capable of being implemented for illustrations of the present invention with referring to appended figures.

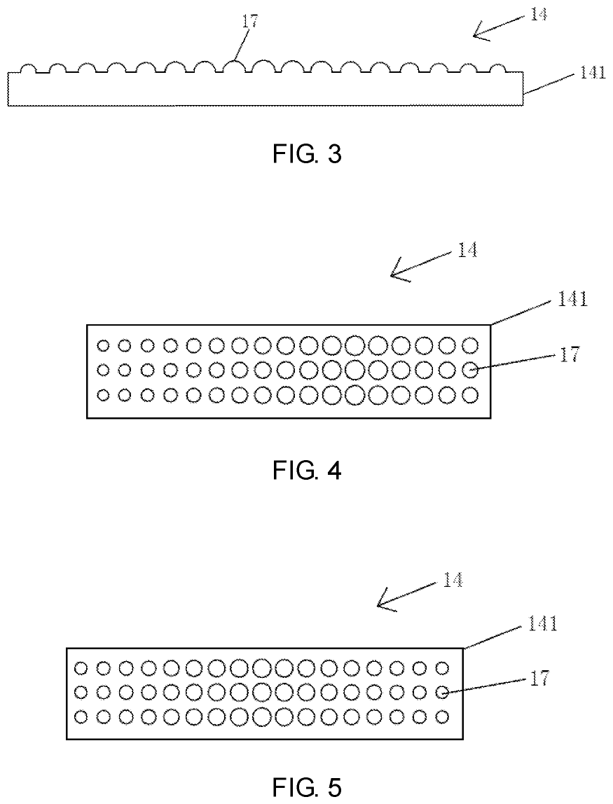

As shown in FIG. 3, the present invention teaches a reflection sheet including a main member 141 and multiple protrusions 17 disposed on a side of the main member 141.

Specifically, as shown in FIGS. 4 and 5, the protrusions 17 have their dimension and density gradually increased from a lateral side of to another lateral side of the main member 141. Alternatively, the protrusions 17 have their dimension and density gradually increased from two lateral sides to a center of the main member 141. The protrusions 17 is able to reflect light from various directions, thereby enhancing light utilization.

As shown in FIGS. 4, 6, and 7, an edge-lit backlight module according to a first embodiment of the present invention includes a back plate 11 and a light source 13, a reflection sheet 14, a light guide plate 15 and optical films 16, all disposed inside the back plate 11.

The light source 13 is disposed to a lateral side of the light guide plate 15. The light emitted from the light source 13 is incident into the light guide plate 15 and then refracted out from the light guide plate 15. The reflection sheet 14 is disposed between the back plate 11 and the light guide plate 15. The optical films 16 includes a lower diffusion sheet 161, a prism sheet 162, and an upper diffusion sheet 163 sequentially stacked above the light guide plate 15.

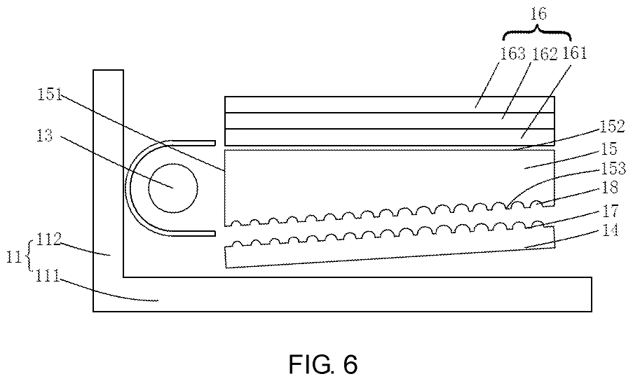

As shown in FIG. 6, the reflection sheet 14 has multiple protrusions 17 on a side adjacent to the light guide plate 15 protruding towards the light guide plate 15. The light guide plate 15 has multiple indentations 18 on a bottom side adjacent to the reflection sheet 14 indented away from the reflection sheet 14. The protrusions 17 is able to reflect light from various directions into the light guide plate 15. The indentations 18 is able to reflect light from various directions inside the light guide plate 15 so that more light may be emitted out of the light guide plate 15 and suffer less total reflection, thereby enhancing light utilization and emission uniformity.

Specifically, the back plate 11 includes a bottom plate 111 and a number of side plates 112. The side plates 112 are perpendicularly joined to edges of the bottom plate 111. The light guide plate 15 includes a light emission face 152 away from the bottom plate 111, a bottom face 153 adjacent to the bottom plate 111, and a light incident face 151 adjacent to a side plate 112. The light source 13 is disposed between the light incident face 151 of the light guide plate 15 and the adjacent side plate 112. The reflection sheet 14 is disposed between the bottom plate 111 and the light guide plate 15.

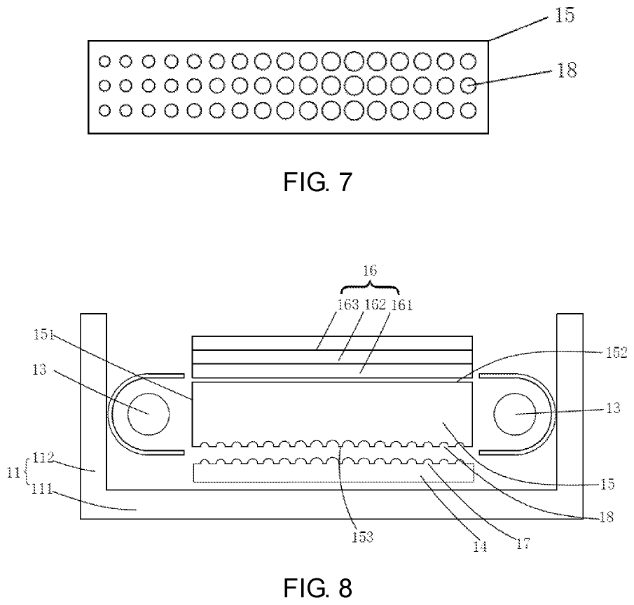

As shown in FIGS. 4 and 7, the protrusions 17 have spherical shapes or, more specifically, incomplete spherical or ellipsoidal shapes. Preferably, the protrusions 17 have semi-spherical or semi-ellipsoidal shapes. The indentations 18 have spherical concaves or, more specifically, incomplete spherical or ellipsoidal concaves. Preferably, the indentations 18 have semi-spherical or semi-ellipsoidal concaves. The semi-spherical or semi-ellipsoidal shapes or concaves may reflect light from various directions. The protrusions 17 and the indentations 18 of course may have other, such as rectangular, shapes or concaves. The present invention does not have specific requirement. Furthermore, the protrusions 17 and the indentations 18 preferably have comparable shapes and concaves.

Specifically, the protrusions 17 and the indentations 18 have greater dimensions and densities as they are located farther away from the light source 13. In the present embodiment, the light guide plate 15 has a wedge shape and the side adjacent to the light source 13 has a greater thickness than that of the side away from the light source 13. Therefore, the bottom side of the light guide plate 15 that has the indentations 18 is slant relative to the light emission face 152. Then, due to the provision of the wedge-shaped light guide plate 15 and the reflection sheet 14, the protrusions 17 and indentations 18 have their dimensions and densities gradually decreased as they are located farther away from the light source 13, so as to maintain a uniform brightness from the LCD panel. Preferably, each protrusion 17 on the reflection sheet 14 is aligned with a corresponding indentation 18 on the light guide plate 15, and the protrusion 17 and the corresponding indentation 18 are complementarily shaped and of an identical dimension.

Specifically, the protrusions 17 may be formed on the reflection sheet 14 through screen printing, and the indentations 18 may be formed on the light guide plate 15 through heat transfer.

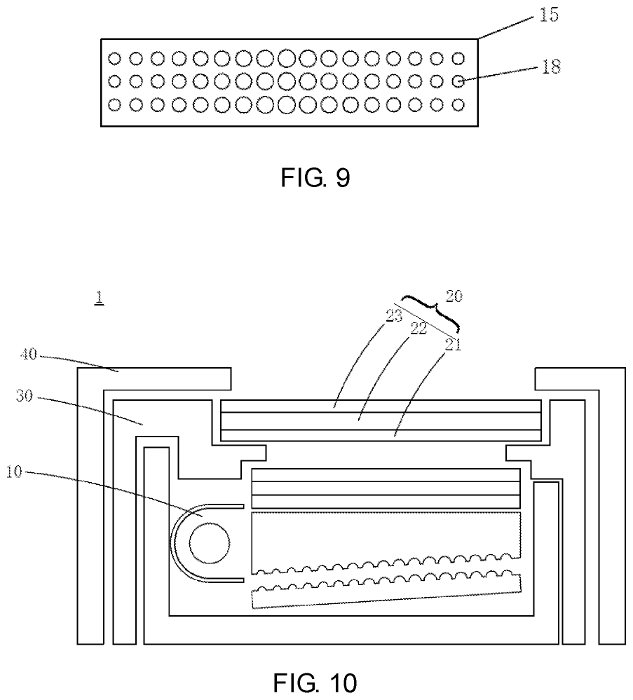

As shown in FIGS. 5, 8, and 9, an edge-lit backlight module according to a second embodiment of the present invention differs from the first embodiment in that there are two light sources 13 respectively disposed to two opposite lateral sides of the light guide plate 15, thereby achieving a dual edge-lit backlight module. Also in the present embodiment, the light guide plate 15 is a flat-shaped light guide plate.

Due to the provision of dual light sources 13, the protrusions 17 and indentations 18 may be distributed symmetrically. On the reflection sheet 14, the protrusions 17 have greater dimensions and densities as they are located farther away from the two light sources 13 and closer to a middle section of the reflection sheet 14. On the light guide plate 15, the indentations 18 have greater dimensions and densities as they are located farther away from the two light sources 13 and closer to a middle section of the light guide plate 15. The other structure and technical effect of the present embodiment are identical to those of the first embodiment, and their details are omitted here.

Based on the above described backlight modules, the present invention further teaches a LCD device.

As shown in FIGS. 3 to 7 and 10, a LCD device 1 according to a first embodiment of the present invention includes a backlight module 10, a LCD panel 20, a plastic frame 30, and a casing 40. The LCD panel 20 is disposed above the backlight module 10. The plastic frame 30 is disposed between the backlight module 10 and the LCD panel 20 for joining the backlight module 10 and the LCD panel 20. The casing 40 covers circumferential areas of the LCD panel 20, the backlight module 10, and the plastic frame 30, thereby forming the complete LCD device 1. The LCD panel 20 includes an array substrate 21, an opposite substrate 23 opposing to the array substrate 21, and a liquid crystal layer 22 sandwiched between the array substrate 21 and the opposite substrate 23. The backlight module 10 is the above described first embodiment of the edge-lit backlight module.

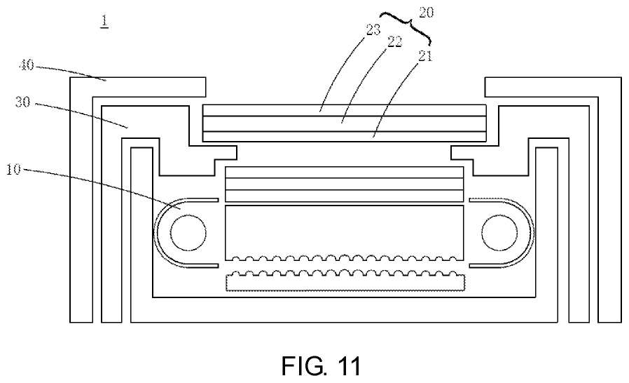

As shown in FIGS. 5, 8, 9, and 11, a LCD device 1 according to a second embodiment of the present invention differs from the first embodiment in that the backlight module 10 is a dual edge-lit backlight module described above.

It should be noted that a conventional edge-lit backlight module have grid dots on a bottom side of the light guide plate, and light entering the light guide plate is reflected by the grid dot and scattered out of the light emission face of the light guide plate. However, the shape and distribution of the grid dots are planar, and light therefore undergoes insufficient reflection and scattering. Light whose incident angle is less than the total reflection angle is not utilized, the light source therefore has an inferior utilization, and the provided backlight suffers limited uniformity. In contrast, the edge-lit backlight module of the present invention provides multiple spherical shaped protrusions and indentations on the reflection sheet and the light guide plate. As the spherical shape is able to reflect light from more directions, light whose incident angle is less than the total reflection angle may still be reflected out of the light guide plate, thereby turning linear light source to planar light source, reducing light attenuation, enhancing light utilization and emission uniformity.

As described above, the reflection sheet taught by the present invention includes a main member and multiple protrusions disposed on the main member. The reflection sheet is able to reflect light from various directions, thereby enhancing light utilization. The edge-lit backlight module taught by the present invention includes a back plate and, inside the back plate, a light source, a reflection sheet, and a light guide plate. The light source is disposed to a lateral side of the light guide plate. The reflection sheet is disposed between the back plate and the light guide plate. Multiple protrusions are provided on a side of the reflection sheet adjacent to the light guide plate. Multiple indentations are provided on a bottom side of the light guide plate adjacent to the reflection sheet. The protrusions and indentations are able to reflect light from various directions so that more light is incident into the light guide plate and emitted out through the light emission face of the light guide plate, enhancing light utilization and emission uniformity. The LCD device taught by the present invention includes the above-described edge-lit backlight module. Through the multiple protrusions provided on a side of the reflection sheet adjacent to the light guide plate and multiple indentations provided on a bottom side of the light guide plate adjacent to the reflection sheet, the protrusions and indentations are able to reflect light from various directions so that more light is incident into the light guide plate and emitted out through the light emission face of the light guide plate, thereby enhancing light utilization and emission uniformity and improving display quality of the LCD device.

Above are embodiments of the present invention, which does not limit the scope of the present invention. Any equivalent amendments within the spirit and principles of the embodiment described above should be covered by the protected scope of the invention.

What is claimed is:

1. A reflection sheet comprising a main member and a plurality of protrusions disposed on a side of the reflection sheet.

2. The reflection sheet according to claim 1, wherein the protrusions have their dimension and density gradually increased from a lateral side of to another lateral side of the main member, or have their dimension and density gradually increased from two lateral sides to a center of the main member.

3. An edge-lit backlight module comprising a back plate, and at least one light source, a reflection sheet, and a light guide plate all housed inside the back plate;
the at least one light source is disposed to a lateral side of the light guide plate;
the reflection sheet is disposed between the back plate and the light guide plate; the reflection sheet has a plurality of protrusions on a side adjacent to the light guide plate protruding towards the light guide plate; and the light guide plate has a plurality of indentations on a bottom side adjacent to the reflection sheet indented away from the reflection sheet.

4. The edge-lit backlight module according to claim 3, wherein there is one light source; the protrusions have greater dimensions and densities on the reflection sheet as they are located farther away from the at least one light source; the indentations have greater dimensions and densities on the light guide plate as they are located farther away from the at least one light source.

5. The edge-lit backlight module according to claim 4, wherein each protrusion on the reflection sheet is aligned with a corresponding indentation on the light guide plate; and the protrusion and the corresponding indentation are complementarily shaped and of an identical dimension.

6. The edge-lit backlight module according to claim 4, wherein the light guide plate has a wedge shape; a side of the light guide plate adjacent to the at least one light source has a greater thickness than that of another side away from the at least one light source; and the reflection sheet is disposed parallel to the bottom side of the light guide plate.

7. The edge-lit backlight module according to claim 3, wherein there are two light sources respectively disposed to two opposite lateral sides of the light guide plate; the protrusions have greater dimensions and densities as they are located farther away from the two light sources and closer to a middle section of the reflection sheet; and the indentations have greater dimensions and densities as they are located farther away from the two light sources and closer to a middle section of the light guide plate.

8. The edge-lit backlight module according to claim 7, wherein each protrusion on the reflection sheet is aligned with a corresponding indentation on the light guide plate; and the protrusion and the corresponding indentation are complementarily shaped and of an identical dimension.

9. The edge-lit backlight module according to claim 3, wherein the back plate comprises a bottom plate and a plurality of side plates perpendicularly joined to edges of the bottom plate; and
the light guide plate comprises a light emission face away from the bottom plate, a bottom face adjacent to the bottom plate, and a light incident face adjacent to a side plate.

10. A liquid crystal display (LCD) device, comprising a backlight module, a LCD panel disposed on top of the backlight module, a plastic frame disposed between the backlight module and the LCD panel, and a casing covering circumferential areas of the LCD panel, the backlight module, and the plastic frame, wherein the backlight module is an edge-lit backlight module as claimed in claim 3.

11. The LCD device according to claim 10, wherein there is one light source;
the protrusions have greater dimensions and densities on the reflection sheet as they are located farther away from the at least one light source; the indentations have greater dimensions and densities on the light guide plate as they are located farther away from the at least one light source.

12. The LCD device according to claim 11, wherein each protrusion on the reflection sheet is aligned with a corresponding indentation on the light guide plate;
and the protrusion and the corresponding indentation are complementarily shaped and of an identical dimension.

13. The LCD device according to claim 11, wherein the light guide plate has a wedge shape; a side of the light guide plate adjacent to the at least one light source has a greater thickness than that of another side away from the at least one light source; and the reflection sheet is disposed parallel to the bottom side of the light guide plate.

14. The LCD according to claim 10, wherein there are two light sources respectively disposed to two opposite lateral sides of the light guide plate; the protrusions have greater dimensions and densities as they are located farther away from the two light sources and closer to a middle section of the reflection sheet; and
the indentations have greater dimensions and densities as they are located farther away from the two light sources and closer to a middle section of the light guide plate.

15. The LCD device according to claim 14, wherein each protrusion on the reflection sheet is aligned with a corresponding indentation on the light guide plate;
and the protrusion and the corresponding indentation are complementarily shaped and of an identical dimension.

16. The LCD device according to claim 10, wherein the back plate comprises a bottom plate and a plurality of side plates perpendicularly joined to edges of the bottom plate; and
the light guide plate comprises a light emission face away from the bottom plate, a bottom face adjacent to the bottom plate, and a light incident face adjacent to a side plate.
